(19) United States
(12) Patent Application Publication
(10) Pub. No.: US 2025/0380302 A1
(43) Pub. Date: Dec. 11, 2025

(54) CHANNEL ACCESS TECHNIQUES FOR FRAME-BASED EQUIPMENT IN SIDELINK COMMUNICATIONS USING SHARED SPECTRUM

(71) Applicant: QUALCOMM Incorporated, San Diego, CA (US)

(72) Inventors: Hao XU, Beijing (CN); Siyi CHEN, Beijing (CN); Shaozhen GUO, Beijing (CN); Chih-Hao LIU, San Diego, CA (US); Xiaoxia ZHANG, San Diego, CA (US); Jing SUN, San Diego, CA (US); Changlong XU, Beijing (CN); Luanxia YANG, Beijing (CN)

(21) Appl. No.: 18/877,219

(22) PCT Filed: Aug. 31, 2022
(86) PCT No.: PCT/CN2022/116083

§ 371 Date: Dec. 19, 2024

(51) Int. Cl. H04W 74/0816; H04W 92/18

(52) U.S. Cl. CPC H04W 74/0816; H04W 92/18

(57) ABSTRACT

Methods, systems, and devices for wireless communications are described, in which devices may operate in a frame based equipment (FBE) mode for sidelink communications. One or more fixed frame period (FFP) configurations may be used by different sidelink devices, and a first device (e.g., a first user equipment UE)) may transmit to one or more other devices an indication of a FFP configuration for sidelink communications. The FFP configuration may include an idle period configuration that is coordinated across multiple devices for initiation of a channel access procedure. Alternatively different sidelink devices may have different FFP configurations, and a joint pattern may be provided for performing the channel access procedure at each of the sidelink devices.

### CROSS REFERENCE

The present application is a 371 national stage filing of International PCT Application No. PCT/CN2022/116083 by XU et al. entitled “CHANNEL ACCESS TECHNIQUES FOR FRAME-BASED EQUIPMENT IN SIDELINK COMMUNICATIONS USING SHARED SPECTRUM,” filed Aug. 31, 2022, which is assigned to the assignee hereof, and which is expressly incorporated by reference in its entirety herein.

### FIELD OF TECHNOLOGY

The following relates to wireless communications, including channel access techniques for frame-based equipment in sidelink communications using shared spectrum.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may support sidelink communications between UEs in a shared radio frequency spectrum. The shared radio frequency spectrum may be a spectrum that is unlicensed, licensed to multiple operators, or licensed to a single operator with opportunistic access by other devices (e.g., a licensed radio frequency spectrum, an unlicensed radio frequency spectrum, or a combination of licensed and unlicensed radio frequency spectrum). Improved techniques for facilitating sidelink communications in a shared radio frequency spectrum may be desirable.

### SUMMARY

The described techniques relate to improved methods, systems, devices, and apparatuses that support channel access techniques for frame-based equipment (FBE) in sidelink communications using shared spectrum. For example, the described techniques provide that a first user equipment (UE) may be configured with a timing of a frame structure for sidelink communications via a shared channel. The timing of the frame structure may correspond to a fixed frame period (FFP), and the first UE may initiate sidelink communications at the boundaries of the FFPs. The first UE may also support techniques for collision avoidance such as through transmitting, to at least a second UE, an indication of a FFP configuration for sidelink communications between at least the first UE and the second UE operating in a FBE mode. The FFP configuration may include an idle period configuration that is coordinated across at least the first UE and the second UE for initiation of a channel access procedure. The first UE may monitor a sidelink channel during a first idle period that is based on the idle period configuration of the FFP configuration, and transmit communications based on the channel access procedure indicating that the sidelink channel is available for sidelink communications. In some cases, the first UE and the second UE may be in a same first group of UEs, and the FFP configuration is used at each UE in the first group of UEs. Alternatively, the first UE and the second UE may have a different FFP configuration, and a joint pattern may be provided for performing the channel access procedure at each of the first UE and the second UE.

A method for wireless communication at a first user equipment (UE) is described. The method may include transmitting, to at least a second UE, an indication of a fixed frame period configuration for sidelink communications between at least the first UE and the second UE operating in a frame-based equipment mode, the fixed frame period configuration including an idle period configuration that is coordinated across at least the first UE and the second UE for initiation of a channel access procedure, monitoring, in accordance with the channel access procedure, a sidelink channel during a first idle period, the first idle period is identified based on the idle period configuration of the fixed frame period configuration, and transmitting a sidelink communication to at least the second UE based on the channel access procedure indicating that the sidelink channel is available for sidelink communications.

An apparatus for wireless communication at a first UE is described. The apparatus may include a processor, memory coupled with the processor, and instructions stored in the memory. The instructions may be executable by the processor to cause the apparatus to transmit, to at least a second UE, an indication of a fixed frame period configuration for sidelink communications between at least the first UE and the second UE operating in a frame-based equipment mode, the fixed frame period configuration including an idle period configuration that is coordinated across at least the first UE and the second UE for initiation of a channel access procedure, monitor, in accordance with the channel access procedure, a sidelink channel during a first idle period, the first idle period is identified based on the idle period configuration of the fixed frame period configuration, and transmit a sidelink communication to at least the second UE based on the channel access procedure indicating that the sidelink channel is available for sidelink communications.

Another apparatus for wireless communication at a first UE is described. The apparatus may include means for transmitting, to at least a second UE, an indication of a fixed frame period configuration for sidelink communications between at least the first UE and the second UE operating in a frame-based equipment mode, the fixed frame period configuration including an idle period configuration that is coordinated across at least the first UE and the second UE for initiation of a channel access procedure, means for monitoring, in accordance with the channel access procedure, a sidelink channel during a first idle period, the first idle period is identified based on the idle period configuration of the fixed frame period configuration, and means for transmitting a sidelink communication to at least the second UE based on the channel access procedure indicating that the sidelink channel is available for sidelink communications.

A non-transitory computer-readable medium storing code for wireless communication at a first UE is described. The code may include instructions executable by a processor to transmit, to at least a second UE, an indication of a fixed frame period configuration for sidelink communications between at least the first UE and the second UE operating in a frame-based equipment mode, the fixed frame period configuration including an idle period configuration that is coordinated across at least the first UE and the second UE for initiation of a channel access procedure, monitor, in accordance with the channel access procedure, a sidelink channel during a first idle period, the first idle period is identified based on the idle period configuration of the fixed frame period configuration, and transmit a sidelink communication to at least the second UE based on the channel access procedure indicating that the sidelink channel is available for sidelink communications.

In some examples of the method, apparatuses, and non-transitory computer-readable medium described herein, the first UE and the second UE may be in a first group of UEs, and where a same fixed frame period configuration is used at each UE in the first group of UEs. Some examples of the method, apparatuses, and non-transitory computer-readable medium described herein may further include operations, features, means, or instructions for receiving sidelink configuration information that indicates a zone identification for sidelink communications, where the first group of UEs each have a same zone identification.

Some examples of the method, apparatuses, and non-transitory computer-readable medium described herein may further include operations, features, means, or instructions for receiving sidelink configuration information that indicates a center node associated with the first group of UEs, and the first group of UEs includes UEs having a proximity to the center node that is less than a threshold value. In some examples of the method, apparatuses, and non-transitory computer-readable medium described herein, the center node is selected at a network entity or at one or more UEs of the first group of UEs.

In some examples of the method, apparatuses, and non-transitory computer-readable medium described herein, the monitoring the sidelink channel may include operations, features, means, or instructions for determining, based on a collision avoidance procedure, to contend for channel access during the first idle period, where the collision avoidance procedure is based on a random starting point for channel contention, a priority rule for channel contention, a reservation indication provided from the second UE, or any combinations thereof and monitoring the sidelink channel during the first idle period is based on the collision avoidance procedure. In some examples of the method, apparatuses, and non-transitory computer-readable medium described herein, the collision avoidance procedure provides that higher priority traffic that is to be transmitted in the sidelink communication is mapped to an earlier starting time for initiating the channel access procedure. In some examples of the method, apparatuses, and non-transitory computer-readable medium described herein, the collision avoidance procedure prioritizes channel contention for UEs based on one or more of an amount of traffic to be transmitted in the sidelink communication, a priority of the traffic to be transmitted, a random selection based on an identification of the UE, a priority indication provided from a center node of a group of UEs that includes the first UE and the second UE, or any combinations thereof. Some examples of the method, apparatuses, and non-transitory computer-readable medium described herein may further include operations, features, means, or instructions for receiving a fixed frame period reservation indication from the second UE for a second idle period and refraining from initiating the channel access procedure during the second idle period based on the fixed frame period reservation indication.

In some examples of the method, apparatuses, and non-transitory computer-readable medium described herein, the second UE may have a different fixed frame period configuration than the first UE, and a joint pattern may be provided for performing the channel access procedure at each of the first UE and the second UE. In some examples of the method, apparatuses, and non-transitory computer-readable medium described herein, both the first UE and the second UE may have a same zone identification for sidelink communications, and where each UE having the same zone identification follows an idle period associated with the fixed frame period configuration of each UE having the same zone identification. In some examples of the method, apparatuses, and non-transitory computer-readable medium described herein, the joint pattern provides that each UE having a first zone identification for sidelink communications and that shares a first fixed frame period configuration follows an idle period associated with the first fixed frame period configuration and the joint pattern provides that the first UE blanks transmissions during a monitoring period of other UEs to which the first UE transmits sidelink communications. In some examples of the method, apparatuses, and non-transitory computer-readable medium described herein, the joint pattern further provides that each UE having the first zone identification blanks transmissions during the monitoring period of other UEs having the first zone identification and a different fixed frame period configuration.

Some examples of the method, apparatuses, and non-transitory computer-readable medium described herein may further include operations, features, means, or instructions for receiving, via sidelink control information, an indication of the fixed frame period configuration for at least the second UE. In some examples of the method, apparatuses, and non-transitory computer-readable medium described herein, the sidelink control information indicates one or more of a periodicity of the fixed frame period, an offset associated with the fixed frame period, a duration of an available channel occupancy time sharing during the fixed frame period, or any combinations thereof. In some examples of the method, apparatuses, and non-transitory computer-readable medium described herein, the sidelink control information that provides the indication of the fixed frame configuration as part of an initial connection that initializes sidelink communications between the first UE and at least the second UE. In some examples of the method, apparatuses, and non-transitory computer-readable medium described herein, the sidelink control information may be provided in an anchor UE groupcast transmission to a set of multiple UEs that each have a first zone identification for sidelink communications, or the sidelink control information is provided separately from each of the set of multiple UEs that each have the first zone identification.

Some examples of the method, apparatuses, and non-transitory computer-readable medium described herein may further include operations, features, means, or instructions for transmitting, prior to the monitoring the sidelink channel, a blanking request to at least the second UE that indicates the second UE is requested to refrain from transmitting during a listen-before-talk (LBT) duration associated with the channel access procedure. In some examples of the method, apparatuses, and non-transitory computer-readable medium described herein, the blanking request may be provided in a sidelink control information transmission from the first UE. In some examples of the method, apparatuses, and non-transitory computer-readable medium described herein, the blanking request may be a one-shot blanking request for a single fixed frame period, or a semi-static blanking request that applies to two or more fixed frame periods. In some examples of the method, apparatuses, and non-transitory computer-readable medium described herein, the blanking request further indicates a priority associated with traffic to be transmitted from the first UE, and where the priority is used at least at the second UE to determine whether to blank transmissions during the LBT duration. In some examples of the method, apparatuses, and non-transitory computer-readable medium described herein, the first UE provides an indication of whether the sidelink communication includes one or more symbols that have been blanked based on a received blanking request from a different UE.

### BRIEF DESCRIPTION OF THE DRAWINGS

FIG. 1 illustrates an example of a wireless communications system that supports channel access techniques for frame-based equipment (FBE) in sidelink communications using shared spectrum in accordance with one or more aspects of the present disclosure.

FIG. 2 illustrates an example of a wireless communications system that supports channel access techniques for FBE in sidelink communications using shared spectrum in accordance with one or more aspects of the present disclosure.

FIG. 3 illustrates examples of different FBE configurations that support channel access techniques for FBE in sidelink communications using shared spectrum in accordance with one or more aspects of the present disclosure.

FIG. 4 illustrates an example of idle periods for different FBE configurations that support channel access techniques for FBE in sidelink communications using shared spectrum in accordance with one or more aspects of the present disclosure.

FIG. 5 illustrates an example of idle periods for different FBE configurations that support channel access techniques for FBE in sidelink communications using shared spectrum in accordance with one or more aspects of the present disclosure.

FIGS. 6 and 7 show block diagrams of devices that support channel access techniques for FBE in sidelink communications using shared spectrum in accordance with one or more aspects of the present disclosure.

FIG. 8 shows a block diagram of a communications manager that supports channel access techniques for FBE in sidelink communications using shared spectrum in accordance with one or more aspects of the present disclosure.

FIG. 9 shows a diagram of a system including a device that supports channel access techniques for FBE in sidelink communications using shared spectrum in accordance with one or more aspects of the present disclosure.

FIGS. 10 and 11 show flowcharts illustrating methods that support channel access techniques for FBE in sidelink communications using shared spectrum in accordance with one or more aspects of the present disclosure.

### DETAILED DESCRIPTION

Some wireless communications systems may support sidelink communications in which one user equipment (UE) may communicate directly with one or more other UEs in a shared spectrum (e.g., shared radio frequency spectrum). In such systems, a UE communicating over a sidelink may support a load based equipment (LBE) mode or a frame based equipment (FBE) mode. In an LBE mode, a UE may contend for access to a shared channel at any time to transmit sidelink data over the shared channel. In an FBE mode, a UE may contend for access to a shared channel at fixed times to transmit sidelink data over the shared channel. For instance, in the FBE mode, the UE may be configured with fixed frame periods (FFPs), and the UE may contend for access to a shared channel at the boundary of an FFP to transmit sidelink data in the FFP. In some cases, however, techniques for configuring a timing of a frame structure for sidelink communications over a shared channel may be undefined. Further, in an FBE system, techniques at a UE for contending for access to a shared channel at the boundary of FFPs may be deficient.

As described herein, a wireless communications system may support efficient techniques for facilitating sidelink communications in a shared spectrum (e.g., in an FBE system). A first UE may be configured with a timing of a frame structure for sidelink communications via a shared channel. The timing of the frame structure may correspond to an FFP, and the first UE may initiate sidelink communications at the boundaries of the FFPs. In some cases, collision avoidance procedures may be provided in which the first UE may transmit, to at least a second UE, an indication of the FFP configuration for sidelink communications. The FFP configuration may include an idle period configuration that is coordinated across at least the first UE and the second UE for initiation of the channel access procedure. The first UE may monitor a sidelink channel during a first idle period that is based on the idle period configuration of the FFP configuration, and transmit communications based on the channel access procedure indicating that the sidelink channel is available for sidelink communications. In some cases, the first UE and the second UE may be in a same first group of UEs, and the FFP configuration is used at each UE in the first group of UEs. Alternatively, the first UE and the second UE may have a different FFP configuration, and a joint pattern may be provided for performing the channel access procedure at each of the first UE and the second UE.

In some cases, the group of UEs may be defined based on a same zone ID that is part of a sidelink configuration, and all UEs of a same zone ID may have a same FFP. In other cases, the group of UEs may be defined based on a proximity to a central node that may be identified by a network node (e.g., a network entity, such as a base station) or selected by the UEs. Within each group of UEs with the same FFP, a collision avoidance technique for contending for channel access to initiate the FFP may be used (e.g., a rule-based determination for which UE is to initiate a FFP, selection based on UE identifier, or an identified center node can initiate a FFP).

In some cases, different UEs may have different FFPs, and a joint pattern for channel access idle periods may be achieved through blanking UE transmissions during contention procedure idle periods of other UEs, and thereby avoiding collisions between one or more UE transmissions and another UE channel access procedure. Multiple options for determining which UEs have shared idle periods may be available. For example, a first option is for all UEs with a same zone ID to not transmit during idle periods of any other UE with the same zone ID. A second option is that a UE will not transmit during idle periods where UEs share a FFP, and will blank transmissions during the LBT time (e.g., less than 16 μs) for UEs with a same zone ID or UEs to which the UE transmits. A third option is that a UE will not transmit during idle periods where UEs share a FFP, and will blank transmissions during the LBT time (e.g., less than 16 μs) for UEs to which the UE transmits (e.g., does not blank for other UEs with a same zone ID unless that UE is transmitted to).

In some cases, UEs can exchange information that indicates FFPs in sidelink control information (SCI) transmitted via a physical sidelink control channel (PSSCH) communication (e.g., SCI-2 in PSSCH during an initial connection configuration). Additionally, or alternatively, the indication of FFPs may be indicated through an anchor UE groupcast transmission. Further, in cases where UEs have different FFPs, the lack of UE transmissions may cause inefficiencies through resource underutilization. In such cases, a UE may transmit an indication of a blanking request, such as a one-bit indication in SCI that indicates presence/absence of a blanking request, or in a two-bit indication where the additional bit indicates a one-shot blanking request or a semi-persistent blanking request. Additionally, a priority of the traffic to be transmitted may be indicated (e.g., by using three more bits in SCI), which may allow other UEs to disregard a blanking request if higher priority traffic is present.

Aspects of the disclosure are initially described in the context of wireless communications systems. Aspects of the disclosure are further illustrated by and described with reference to FFP configurations, apparatus diagrams, system diagrams, and flowcharts that relate to channel access techniques for FBE in sidelink communications using shared spectrum.

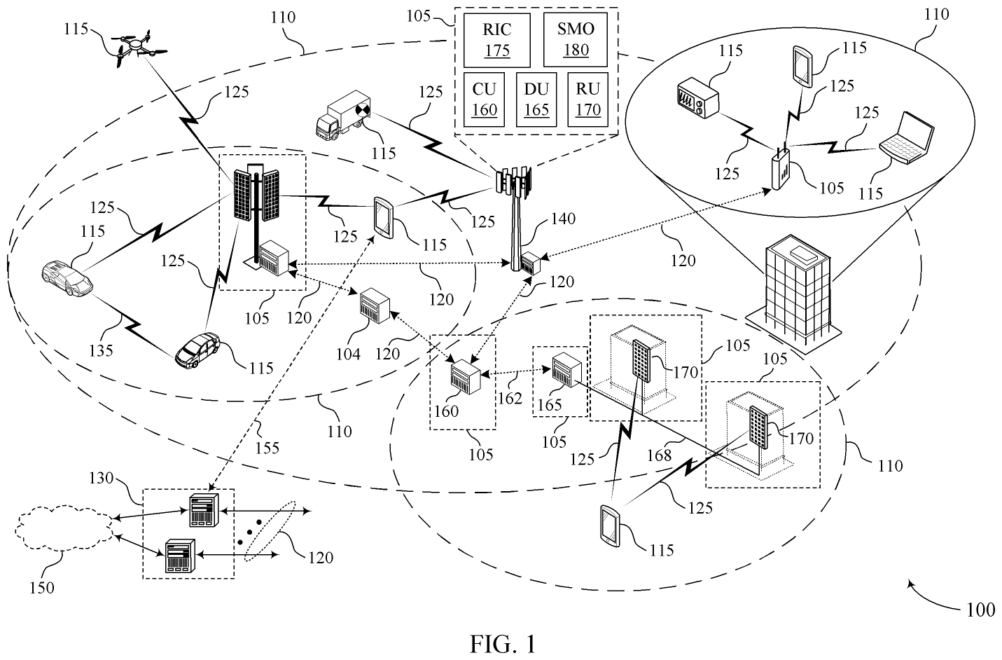

FIG. 1 illustrates an example of a wireless communications system 100 that supports channel access techniques for FBE in sidelink communications using shared spectrum in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support sidelink communication using fixed frame periods as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may utilize both unshared (e.g., licensed) and shared (e.g., unlicensed, licensed to more than one operator, licensed to one or more operators with opportunistic use) radio frequency spectrum bands. For example, the wireless communications system 100 may employ License Assisted Access (LAA), LTE-Unlicensed (LTE-U) radio access technology, NR technology in an unlicensed band (NR-U, including sidelink-U) such as the 5 GHz industrial, scientific, and medical (ISM) band. When operating in unlicensed radio frequency spectrum bands, devices such as the network entities 105 and the UEs 115 may employ carrier sensing for collision detection and avoidance. For example, the network entities 105 and the UEs 115 may employ listen-before-talk (LBT) procedures to ensure a frequency channel (e.g., an LBT subchannel or a frequency band that is accessible via an LBT procedure) is clear before transmitting data. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

An LBT procedure may be an example of a channel access procedure. A channel access procedure may include monitoring a channel, determining whether the channel is clear based on the monitoring, and transmitting on the channel if the channel is clear. A device may determine that a channel is clear (e.g., available for use) after monitoring the channel and failing to detect a transmission on the channel or failing to detect a transmission on the channel with a signal strength satisfying a threshold. Alternatively, the device may determine that the channel is not clear (e.g., unavailable for use) after monitoring the channel and detecting one or more transmissions on the channel or detecting one or more transmissions on the channel with signal strengths satisfying a threshold. A UE 115 may initiate a channel access procedure by monitoring a channel for a transmission from another device (e.g., another UE 115 or a network entity 105). In some cases, initiating a channel access procedure may refer to performing the channel access procedure.

In some implementations, there may be different categories of LBT procedures, including category 1 LBT (e.g., no LBT), category 2 LBT (e.g., LBT including one-time channel sensing for a fixed period without a back-off period), category 3 LBT (e.g., LBT with a random (or other) back-off period and a fixed sized contention window), and category 4 LBT (e.g., LBT with a random (or other) back-off period and a variable sized contention window). In some cases, a category 2 LBT procedure may be referred to as a one-time or one-shot LBT procedure where a UE 115 may perform channel sensing for a defined duration (e.g., 25 μs). Further, a category 4 LBT procedure may be referred to as a fairness-based LBT procedure for performing channel sensing with a backoff, where the backoff may be used to prevent a UE 115 from accessing a channel immediately after detecting that the channel is clear.

The wireless communications system 100 may support sidelink communications between UEs 115 in a shared (e.g., unlicensed) spectrum. Sidelink communications may take place in transmission or reception resource pools (e.g., sidelink resource pools). A minimum resource allocation unit for sidelink communications may be a sub-channel in a frequency domain, and a resource allocation in a time domain for sidelink communications may be one slot. Some slots may not be available for sidelink (e.g., a subset of total slots of a carrier may be available for sidelink), and some slots may contain feedback resources. In some aspects, an RRC configuration for sidelink communications may be preconfigured (e.g., preloaded on a UE 115) or signaled to a UE 115 (e.g., from a network entity 105). In some examples, a network entity 105 facilitates the scheduling of resources for sidelink communications (e.g., in a resource allocation mode 1). In other cases, sidelink communications are carried out between the UEs 115 without the involvement of a network entity 105 (e.g., in a resource allocation mode 2).

In some aspects, a UE 115 communicating over a sidelink in a shared spectrum may support an LBE mode or an FBE mode. The UE 115 may receive system information (e.g., remaining minimum system information (RMSI)) from a network entity 105 indicating an FBE mode in which the UE 115 may operate (e.g., a semi-static channel access mode). In an LBE mode, a UE 115 may contend for access to a shared channel at any time to transmit sidelink data over the shared channel. In an FBE mode, a UE 115 may contend for access to a shared channel at fixed times to transmit sidelink data over the shared channel. For instance, in the FBE mode, the UE may be configured with FFPs, and the UE may contend for access to a shared channel at the boundary of an FFP to transmit sidelink data in the FFP. In some cases, a UE 115 may receive (e.g., in a system information block 1 (SIB1) from a network entity 105) an indication of an FFP configuration for the UE 115. The FFP configuration may indicate the FFPs (e.g., the periodicity of radio frames) within which the UE 115 may communicate. In some examples, the FFP configuration may be signaled to the UE 115 with UE-specific RRC signaling (e.g., for an FBE secondary cell (SCell)).

An FFP may include an idle period and a period for transmitting data, and in some cases an FFP may be restricted to values of 1 ms, 2 ms, 2.5 ms, 4 ms, 5 ms, and 10 ms (e.g., including the idle period). The starting positions of FFPs within every two radio frames may be from an even radio frame and may be given by i*P, where

$$i = \{ 0 , 1 , … , \frac{20}{P - 1} \}$$

and P is the fixed frame period in ms. The idle period (e.g., in an FFP) for a given subcarrier spacing (SCS) may be equal to

$$⌈ \frac{Minimum idle period allowed by regulations}{Ts} ⌉ ,$$

where a minimum idle period allowed is equal to max (5% of FFP, 100 μs), Ts is a symbol duration for a given SCS, and a physical random access channel (PRACH) resource is considered invalid if it overlaps with an idle period of an FFP when an FBE mode of operation is indicated. Table 1 provides the minimum occupied numbers of symbols for an idle mode in an FFP for different SCSs.

TABLE 1
Minimum occupied numbers of symbols for an
idle period in an FFP for different SCSs

| | The minimum occupied number |
|---|---|
| SCS (kHz) | of symbols for idle |
| 15 | 2 |
| 30 | 3 |
| 60 | 6 |
| 120 | 12 |

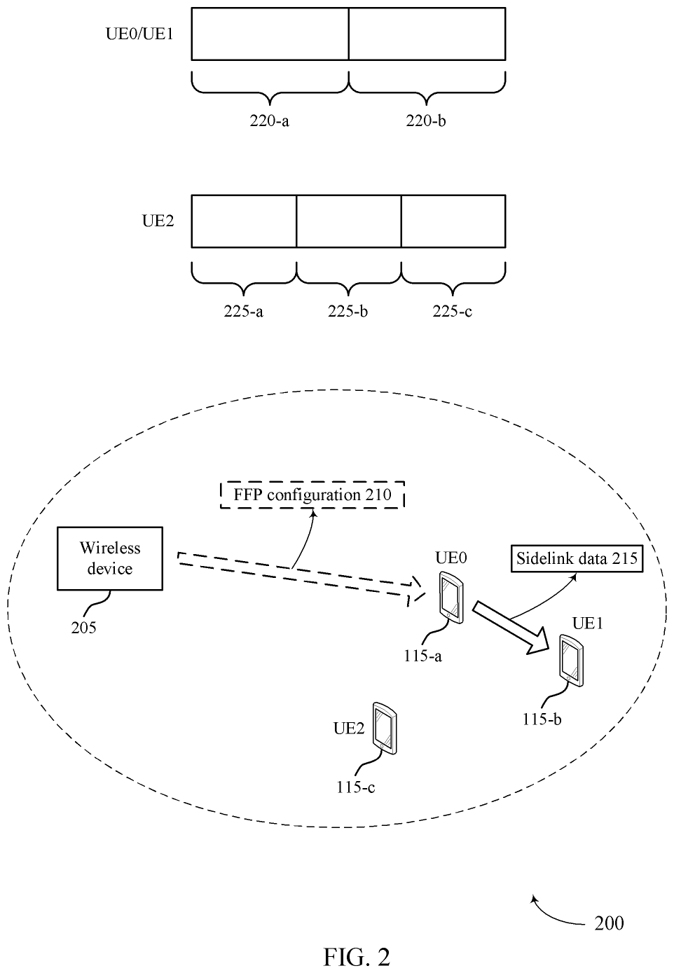

FIG. 2 illustrates an example of a wireless communications system 200 that supports channel access techniques for FBE in sidelink communications using shared spectrum in accordance with one or more aspects of the present disclosure. The wireless communications system 200 includes a wireless device 205, which may be an example of a network entity 105 or a UE 115 described with reference to FIG. 1. The wireless communications system 200 also includes a UE 115-a (UE0), a UE 115-b (UE1), and a UE 115-c (UE2), which may be examples of UEs 115 described with reference to FIG. 1. The wireless communications system 200 may implement aspects of the wireless communications system 100. For instance, the wireless communications system 200 may support channel access techniques for FBE in sidelink communications using shared spectrum (e.g., in an FBE system).

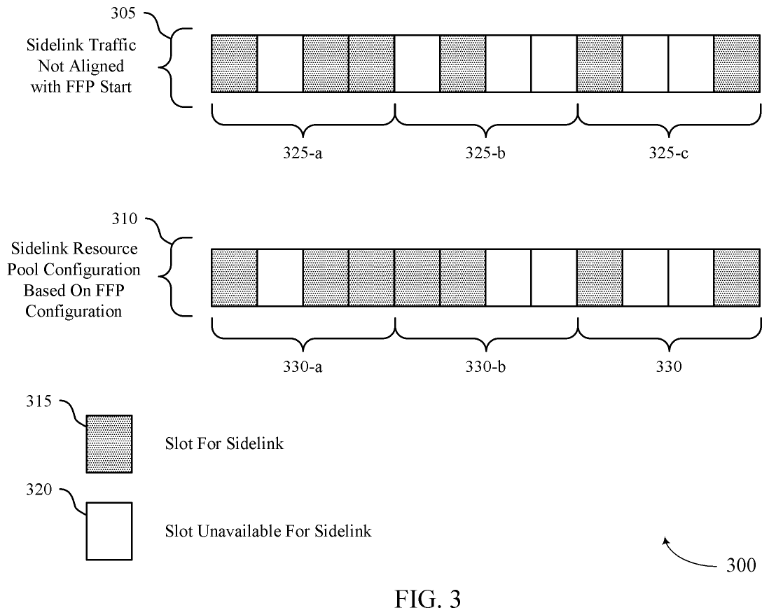

In accordance with various aspects, prior to communicating sidelink data 215 with the UE 115-b in a shared channel (e.g. in a shared or unlicensed spectrum), the UE 115-a may identify an FFP configuration for sidelink communications in the shared channel. The FFP configuration may refer to a configuration of a timing of a frame structure for sidelink communications in a shared channel, where the frame structure includes multiple frame periods having a fixed frame duration (e.g., multiple FFPs). An example of different FFP configurations is illustrated in FIG. 3. The FFP configuration may indicate a periodicity of radio frames (e.g., a length of FFPs), and the UE 115-a may contend for access to the shared channel at the boundary of these FFPs. In an example, the UE 115-a (UE0) and the UE 115-b (UE1) may be configured to communicate during FFPs 220, and the UE 115-c (UE2) may be configured to communicate during FFPs 225. A length of the FFPs 220 and the FFPs 225 (e.g., the periodicities of radio frames configured for UE0, UE1, and UE2) may be the same or may be different.

In some aspects, the wireless device 205 may transmit an indication of the FFP configuration 210 to the UE 115-a for sidelink communications in the shared channel. For example, if the wireless device 205 is a network entity 105, the network entity 105 may transmit the FFP configuration 210 to the UE 115-a in an RRC configuration. For instance, the network entity 105 may configure the UE 115-a with the FFP configuration 210 using RRC signaling (e.g., for a resource allocation mode 1 for sidelink communications). Because the network entity 105 may identify sidelink traffic at the UE 115-a (e.g., for transmission by the UE 115-a), and the network entity 105 may identify periodic traffic for sidelink transmission from the UE 115-a, the network entity may be able to provide a suitable FFP configuration 210 to the UE 115-a. That is, the network entity may determine the FFP configuration 210 for the UE 115-a based on the sidelink traffic at the UE 115-a (e.g., to maximize throughput). In an example, the FFP configuration 210 may be based on an amount of sidelink traffic at the UE 115-a, an average length of bursts of sidelink transmissions from the UE 115-a, etc.

In other examples, the wireless device 205 may be a UE 115, and may transmit the FFP configuration 210 to the UE 115-a in a PC-5 RRC configuration (e.g., using a connection to the UE 115-a via a PC-5 interface). In such cases, the UE 115 providing the FFP configuration 210 to the UE 115-a may be referred to as an anchor UE 115 and may provide control information to multiple UEs 115 (e.g., out-of-coverage UEs). For instance, the anchor UE 115 may provide FFP configurations to the multiple UEs 115 (e.g., including the UE 115-a). In some examples, the anchor UE 115 for the multiple UEs 115 may be preconfigured (e.g., at a programmable logic controller (PLC)). In other examples, the anchor UE 115 for the multiple UEs 115 may be RRC configured. In yet other examples, the anchor UE 115 may be selected by the multiple UEs 115 (e.g., multiple users may form a group and may select a center node as the anchor UE 115).

In some cases, the anchor UE 115 may support channel access techniques for FBE in sidelink communications using shared spectrum by providing to the UE 115-a, the FFP configuration. For instance, the anchor UE 115 may receive an indication of ongoing traffic from the multiple UEs 115 connected to the anchor UE 115 (e.g., an indication of a traffic pattern at each of the multiple UEs 115), and the anchor UE 115 may determine the FFP configuration for each UE 115 based on the traffic pattern at the UE 115 (e.g., and the traffic patterns at other UEs 115). Additionally, or alternatively, the anchor UE 115 may receive information from a network entity 105 (e.g., related to the traffic pattern at each UE 115 of the multiple UEs 115), and the anchor UE 115 signal the FFP configuration based on the information received from the network entity 105 (e.g., for a resource allocation mode 1 for sidelink communications). In other aspects, the FFP configuration may be preconfigured at the UE 115-a, or the UE 115-a may self-configure the FFP configuration (e.g., each UE 115 may configure its own FFP based on its own traffic).

Once the UE 115-a is able to identify a suitable FFP configuration, the UE 115-a may communicate with other UEs 115 (e.g., the UE 115-c) in accordance with the FFP configuration. For instance, the UE 115-a may perform a channel access procedure to gain access to a COT (e.g., within an FFP or spanning one or more FFPs), and the UE 115-a may transmit sidelink data 215 to the UE 115-c in the COT. In addition, the UE 115-a may support efficient techniques for contending for access to a shared channel at the boundary of FFPs in accordance with an FFP configuration. If the UE 115-a has no sidelink data 215 to transmit at the beginning of an FFP, the UE 115-a may not initiate a channel access procedure (e.g., initiate an FFP or COT) to gain access to a shared channel during the FFP. Otherwise, if the UE 115-a has sidelink data 215 to transmit at the beginning of an FFP, and the UE 115-a is capable of sharing a COT with another UE 115, the UE 115-a may use the techniques described herein to determine whether to initiate a channel access procedure to occupy a shared channel during the FFP or to share a COT with another UE 115.

In accordance with some aspects, in cases where multiple FFPs are present in sidelink communications, in order to reduce the probability that one UE 115 blocks one or more other UEs 115 from channel access, a group based FFP configuration may be implemented. In such cases, UEs in a same group may share a same period and offset of FFP. With this condition, each UE 115 may observe an idle period according to the group based FFP configuration. In some cases, if UE 115-a (UE0) at a given time is initiating a COT, the applicable FFP for the UE 115-a is the FFP associated with the UE 115-a. In other cases, if UE 115-a (UE0) at a given time is sharing a COT initiated by UE 115-c (UE2), the applicable FFP for UE 115-a (UE0) is the FFP associated with UE 115-c (UE2). In each case, a UE 115 may not transmit anything during the LBT time (e.g., less than 16 μs) right before the FFP start of the UEs 115 in the same group. In some cases, the group of UEs 115 may be based on a zone ID provided with sidelink configuration information, and users with same zone ID share a same FFP configuration. In other cases, a center node may be identified (e.g., an anchor UE 115 selected amongst multiple UEs 115 or indicated by a network entity), and a distance between the center node and other UEs 115 lower than a threshold value indicates that the UEs 115 share a same zone ID and are thus in a same group.

In some cases, if all UEs 115 in the group align the FFP, multiple UEs 115 may contend the channel at the same time and cause a collision. In order to reduce the likelihood of collisions in LBT procedures among multiple UEs 115 in the group, the UEs 115 may perform one or more collision mitigation procedures. For example, a random the start point for the LBT procedure may be provided such as through random selection of a cyclic prefix (CP) extension at each UE 115. Additionally, or alternatively, a mapping rule may be provided between the length of CP extension and traffic priority (e.g., higher priority traffic may be mapped to shorter CP extensions).

In some cases, a set of one or more rules may be defined for determining which UE 115 may initiate channel contention for an FFP. For example, a predefined rule may be provided (e.g., via sidelink configuration information, or a predefined rule programmed at each UE 115) that indicates which device can initiate the FFP (e.g., a UE 115 with longer traffic has higher probability to initiate the FFP, a UE 115 with higher priority traffic has higher probability to initiate the FFP, or combinations thereof). In other examples, UEs 115 may randomly determine which device can initiate the FFP (e.g., based on UE ID). In further examples, a network entity or center node may decide which UE 115 can initiate the FFP (e.g., for mode 1, a network entity can assign the proper UE 115 to initiate the FFP based on the sidelink traffic pattern, or for mode 2, all sidelink devices in the same group will inform their own traffic to a center node, and center node may decide which UE can initiate the FFP based on the collected information). In still further examples, an FFP reservation field may be provided with SCI 1 (e.g., in an FFP reservation field that indicates which FFP a UE 115 requests), and other UEs 115 may avoid contenting for channel access for the reserved FFP.

FIG. 3 illustrates an example of different FBE configurations 300 that support channel access techniques for FBE in sidelink communications using shared spectrum in accordance with one or more aspects of the present disclosure. A UE 115 may communicate using a number of slots, and sidelink UEs may be use a subset of these slots for sidelink communications (e.g., according to a sidelink resource pool). The slots for communications at the UE 115 may include slots available for sidelink 315 and slots unavailable for sidelink 320. In the example of FIG. 3, a length of an FFP may be configured as 4 physical slots, and an FFP may be 2 ms with an SCS of 30 kHz. In some cases, there may be one or more ways to structure FFPs (e.g., and the alignment of FFPs and logical slots) for sidelink communications in a shared spectrum. An FFP may follow specified values or a subset of these values.

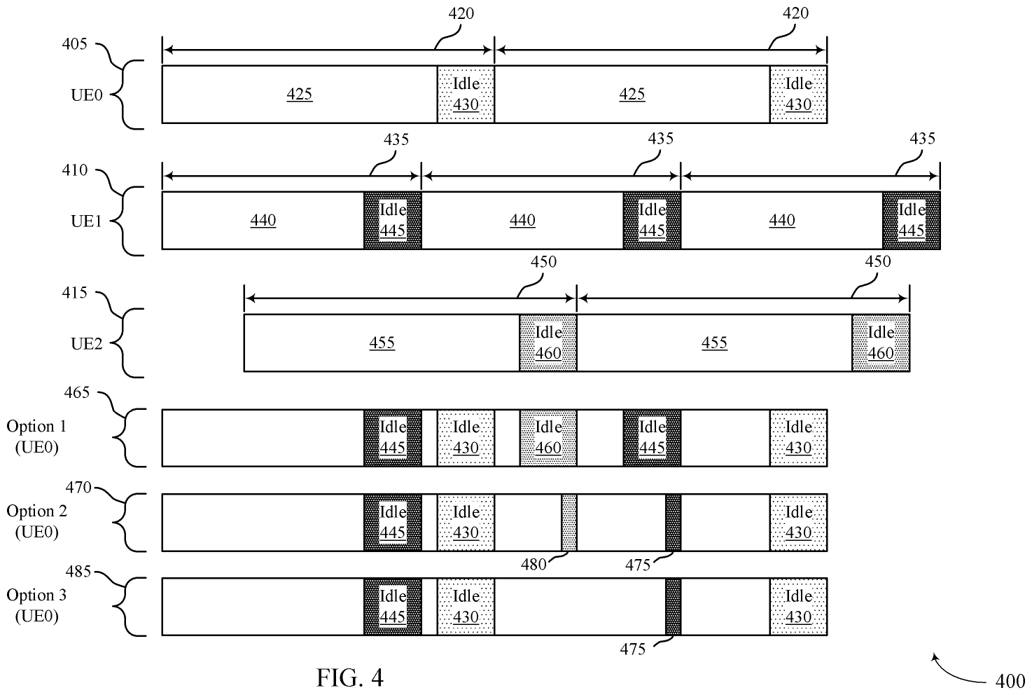

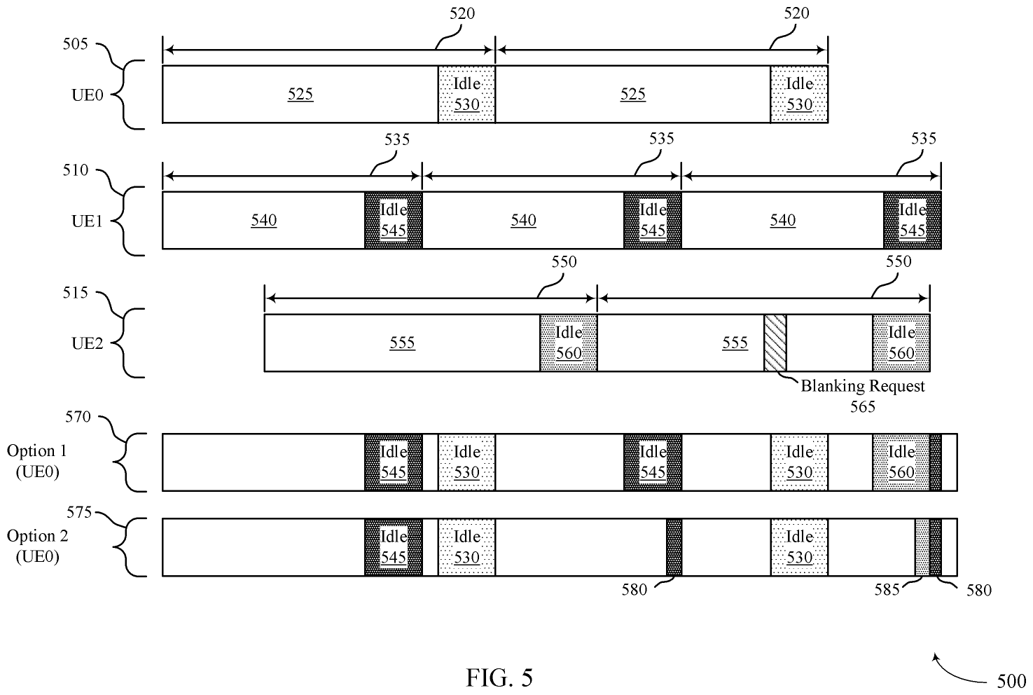

In a first example 305, three FFPs 325 are illustrated, including a first FFP 325-a, a second FFP 325-b, and a third FFP 325-c. In this example, sidelink traffic may not be aligned to the starting point of the second FFP 325-b, because a first slot available for sidelink in the second FFP 325-b is not the first slot in the second FFP 325-b. Thus, a UE 115 may not occupy a channel during the second FFP 325-b. Instead, the UE 115 may occupy a channel during the first FFP 325-a and the third FFP 325-c. In a second example 310, a resource configuration of a sidelink resource pool may be based on an FFP configuration. The resource configuration of the sidelink resource pool may ensure that a slot for sidelink 315 is located at an FFP starting point (e.g., a first slot of each FFP). For instance, in the second example 310, a first slot in each of the FFPs 330, including first FFP 330-a, second FFP 330-b, and third FFP 330-c, may be an available slot for sidelink 315. Thus, a UE 115 may occupy a channel during each FFP 330 of this example. A UE 115 in the wireless communications system 100 may use any of the FFP structures described with reference to FIG. 3 for sidelink communications in a shared spectrum, in accordance with various techniques such as discussed herein. As discussed with reference to FIG. 2, in some aspects UEs 115 in a same group of UEs may use a same FFP. In other aspects, UEs 115 in a same group of UEs may use different FFPs, and exemplary techniques for channel contention in such aspects are discussed with reference to FIGS. 4 and 5.

FIG. 4 illustrates an example of idle periods for different FBE configurations 400 that support channel access techniques for FBE in sidelink communications using shared spectrum in accordance with one or more aspects of the present disclosure. In this example, three UEs 115 may be present and have different FFP configurations, including a first FFP configuration 405 for a first UE (UE0), a second FFP configuration 410 for a second UE (UE1), and a third FFP configuration 415 for a third UE (UE2). The first FFP configuration 405 may have a first FFP duration 420, which may include an associated transmit period 425 and idle period 430. The second FFP configuration 410 may have a second FFP duration 435, which may include an associated transmit period 440 and idle period 445. The third FFP configuration 415 may have a third FFP duration 450, which may include an associated transmit period 455 and idle period 460.

In accordance with various aspects, such different FFPs (e.g., different periods and offsets) for UEs with a same zone ID or within relatively close proximity may result in one UE persistently blocking one or more other UEs. In order to avoid such persistent blocking, a joint pattern may be configured across each of the UEs in a same group of UEs (e.g., for UEs having a same zone ID). FIG. 4 illustrates multiple options for such a joint pattern, although other examples may be implemented and are within the scope of the present disclosure. In each described option in the example of FIG. 4, the first UE (UE0) shares the second UE's (UE1's) FFP during a first instance of first FFP duration 420, the first UE (UE0) transmits data to the second UE (UE1), and each of the first UE (UE0), the second UE (UE1), and the third UE (UE2) are in a same group of UEs (e.g., UEs having a same zone ID, or in relatively close proximity). In a first option 465, the first UE (UE0) may follow all the idle period of each of the first FFP 420, second FFP 435, and third FFP 450 for UEs which have the same zone ID and for UEs that the first UE (UE0) transmits to. In this first option 465, the first UE does not transmit anything during instances of the first idle period 430, second idle period 445, or third idle period 460.

In a second option 470, UE0 may follow the idle period of the FFP of the UEs for which it is sharing an FFP start time, which corresponds to UE1 in this example. In such an option 470, for other UEs, corresponding to UE2 in this example, which may include UEs with the same zone ID and the UEs the first UE transmits to, UE0 may refrain from transmissions during the LBT time (e.g., less than 16 μs) right before the FFP start of the other UEs (e.g., UE1 in subsequent FFPs 420, and UE2). Thus, in the example of FIG. 4, for the second option 470, UE0 follows first idle period 430 and second idle period 445 for a first instance of FFP 420, and refrains from transmitting during a first LBT 475 of UE1 in a subsequent instance of FFP 420, and a second LBT 480 of UE2.

In a third option 485, UE0 may follow the idle period of the FFP of the UEs which it is sharing an FFP start time (e.g., corresponding to UE1 during a first instance of FFP 420 in this example) and for other UEs does not transmit during the LBT time (e.g., less than 16 μs) right before the FFP start of UEs to which UE0 transmits, corresponding to UE1 in this example, Thus, the third option 485 of the example of FIG. 4 provides that UE0 follows the first idle period 430 and the second idle period 445 during a first instance of FFP 420, and UE0 refrains from transmitting during first LBT 475 of UE1 during a subsequent instance of FFP 420.

As different UEs have different FFPs, FFP configurations may be shared with other UEs, and each UE may use the shared FFP configuration to determine the joint pattern for performing channel access. In some cases, UEs may use SCI (e.g., SCI2) to indicate the FFP configuration. In some cases, the SCI may indicate a period and offset of FFP, or may include a dynamic indication of the duration of the available sharing period. In other cases, UEs may exchange FFP configurations during an initial sidelink connection establishment (e.g., through physical sidelink shared channel (PSSCH) transmissions). In some cases, FFP configurations for a group of UEs with a same zone ID may be shared among the group. For example, an anchor UE may groupcast the FFP configuration of all UEs with the same zone ID, or each UE may announce its FFP configuration in SCI (e.g., in SCI2). In the example of FIG. 4, in certain cases resource consumption may be used as UEs with same zone ID will not contend for a subsequent FFP irrespective of whether other UEs contend for the channel or not. In accordance with various aspects, a UE may transmit a blanking request for a subsequent FFP, and other UEs may refrain from channel contention based on the blanking request and otherwise contend for channel access. Examples of such blanking indication techniques are discussed with reference to FIG. 5.

FIG. 5 illustrates an example of idle periods for different FBE configurations 500 that support channel access techniques for FBE in sidelink communications using shared spectrum in accordance with one or more aspects of the present disclosure. In this example, similarly as with the examples of FIG. 4, three UEs 115 may be present and have different FFP configurations, including a first FFP configuration 505 for a first UE (UE0), a second FFP configuration 510 for a second UE (UE1), and a third FFP configuration 515 for a third UE (UE2). The first FFP configuration 505 may have a first FFP duration 520, which may include an associated transmit period 525 and idle period 530. The second FFP configuration 510 may have a second FFP duration 535, which may include an associated transmit period 540 and idle period 545. The third FFP configuration 515 may have a third FFP duration 550, which may include an associated transmit period 555 and idle period 560.

In accordance with various aspects, a UE may transmit a blanking request 565 that may indicate to other UEs that the UE that transmits the blanking request 565 will contend for channel access for a subsequent FFP. In the example of FIG. 5, the third UE (UE2) may transmit a blanking request 565 during a second instance of the third FFP duration 550, that indicates that UE2 will contend for channel access in a subsequent instance of the third FFP duration 550 (e.g., a next FFP instance in time). The blanking request 565 may indicate to other UEs, such as UE0, to follow an idle period, or refrain from transmissions during an LBT time, for an FFP associated with the blanking request 565. In each described option in the example of FIG. 5, the first UE (UE0) shares the second UE's (UE1's) FFP during a first instance of first FFP duration 520, the first UE (UE0) transmits data to the second UE (UE1), and each of the first UE (UE0), the second UE (UE1), and the third UE (UE2) have a same zone ID. In a first option 570, UE0 may follow the idle period of each of the first FFP 520 and the second FFP 535 for UEs that UE0 transmits to, shares an FFP start time, or that transmit blanking request 565. In this first option 570, the UE0 may not transmit anything during instances of the first idle period 530 and the second idle period 545, and may not transmit during an instance of the third idle period 560 that follows blanking request 565.

In a second option 575, UE0 may follow the idle period of the FFP of the UEs for which it is sharing an FFP start time, which corresponds to UE1 in this example for a first instance of first FFP duration 520. In such an option 575, for other UEs, corresponding to UE1 in a subsequent instance of first FFP duration 520 and UE2 in this example, UE0 may refrain from transmissions during the LBT time (e.g., less than 16 μs) right before the FFP start of UEs that that UE0 transmits to, or that transmit blanking request 565 (e.g., UE1 and UE2 in subsequent FFPs 420). Thus, in the example of FIG. 5, for the second option 575, UE0 follows first idle period 530 and second idle period 545 for a first instance of FFP 420, and refrains from transmitting during a first LBT 580 of UE1 in a subsequent instance of FFP 420, and a second LBT 585 of UE2 that occurs subsequent to blanking request 565.

In some cases, the blanking request 565 may be a one-bit indication provided in SCI to indicate if there is blanking request or not. In some cases, the blanking request 565 may be provided in each instance a device desires to contend for channel access, which may be referred to as a one-shot blanking request. In other cases, the blanking request 565 may be a persistent or semi-static blanking request that applies to multiple subsequent FFPs, which may be referred to as a semi-static blanking request. Such a semi-statis blanking request may allow a device that has periodic traffic to avoid transmitting a separate blanking request 565 for each transmission. In some cases, an indication of a one-shot blanking request or a semi-static blanking request may be provided through a bit that is transmitted with SCI (e.g., SCI 2). In such examples, one bit of the blanking request 565 may indicate if there is one shot request and the other bit may to indicate if there is a semi-static blanking request. In other examples, RRC configuration may be provided that may configure blanking requests 565. In some cases, a UE with ongoing traffic may have time constraints and high priority traffic, and the UE may not want to stop its own traffic and keep silent to let other UEs contend for the channel during an FFP. In such cases, along with the blanking request 565, a priority indication of the associated traffic may also be provided, and a UE that receives the blanking request 565 may determine whether or not to refrain from transmissions during the idle period or LBT time right before the associated FFP start. In some cases, a priority indication may be provided with three bits in the blanking request 565, to indicate up to eight different priority levels.

Additionally, or alternatively, a UE (e.g., UE1) that dynamically blanks one or more symbols for channel contention of other UEs (e.g., UE2) may provide an indication to one or more other UEs (e.g., UE0, etc.) that are in communication with the UE of which symbols are blanked. For example, a UE (e.g., UE2) may transmit blanking request 565 and a receiving UE (e.g., UE1) may determine to honor the blanking request, and may indicate the actual transmit symbols used for sidelink communications with one or more other UEs in SCI, such as through a dynamic indication of the actual transmit length of symbols, a dynamic indication of a number of blanking symbols, and/or a location of blanking symbols.

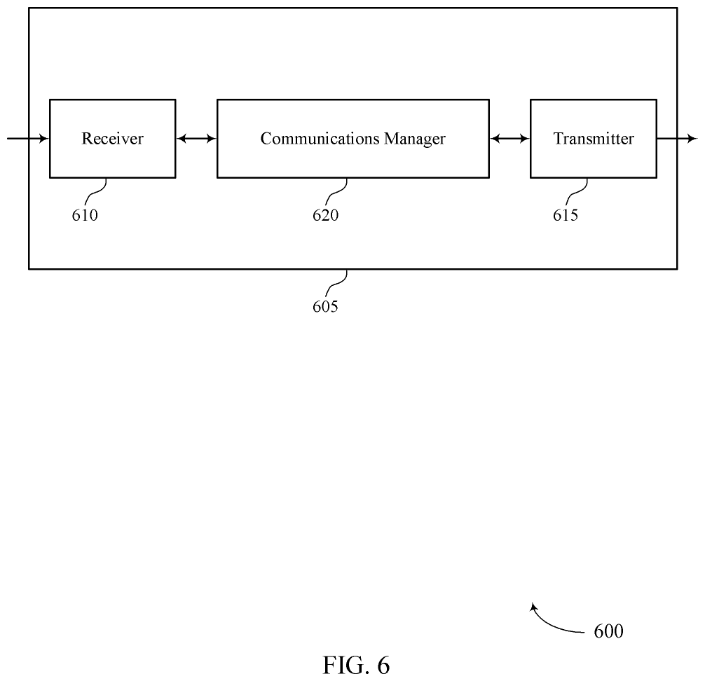

FIG. 6 shows a block diagram 600 of a device 605 that supports channel access techniques for FBE in sidelink communications using shared spectrum in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to channel access techniques for FBE in sidelink communications using shared spectrum). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to channel access techniques for FBE in sidelink communications using shared spectrum). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of channel access techniques for FBE in sidelink communications using shared spectrum as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first UE in accordance with examples as disclosed herein. For example, the communications manager 620 may be configured as or otherwise support a means for transmitting, to at least a second UE, an indication of a FFP configuration for sidelink communications between at least the first UE and the second UE operating in a FBE mode, the FFP configuration including an idle period configuration that is coordinated across at least the first UE and the second UE for initiation of a channel access procedure. The communications manager 620 may be configured as or otherwise support a means for monitoring, in accordance with the channel access procedure, a sidelink channel during a first idle period, the first idle period is identified based on the idle period configuration of the FFP configuration. The communications manager 620 may be configured as or otherwise support a means for transmitting a sidelink communication to at least the second UE based on the channel access procedure indicating that the sidelink channel is available for sidelink communications.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing, reduced overhead, and reduced power consumption. In particular, because the device may provide COT sharing or may be configured with whether to initiate a channel access procedure or share a COT, the device may more efficiently contend for access to a shared channel and may avoid performing channel access procedures unnecessarily. As a result, less time and processing resources at the device may be used for channel access procedures, and the device may achieve the reduced processing, reduced overhead, reduced power consumption, or any combinations thereof.

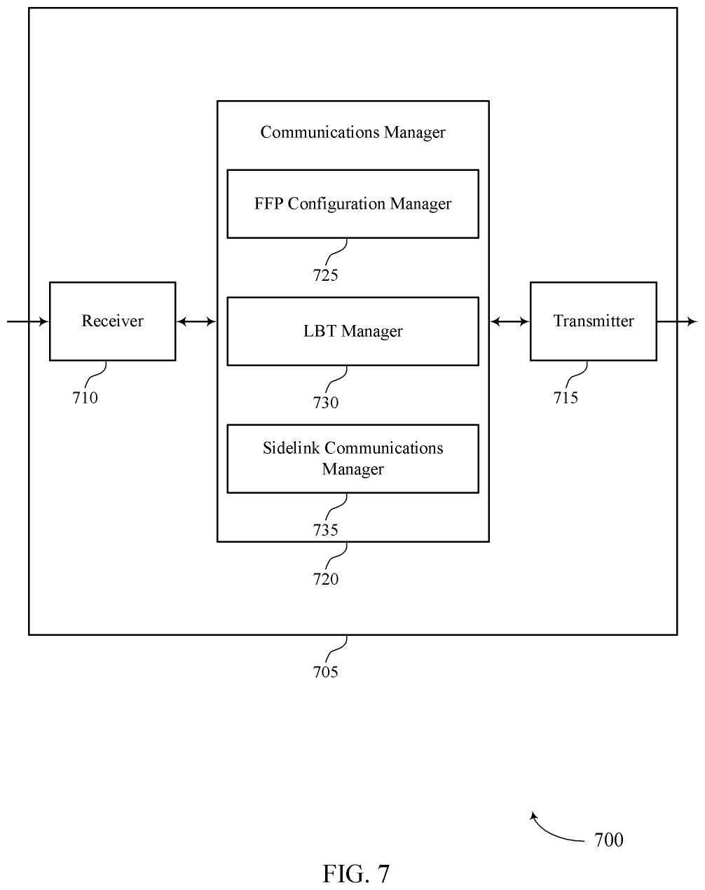

FIG. 7 shows a block diagram 700 of a device 705 that supports channel access techniques for FBE in sidelink communications using shared spectrum in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to channel access techniques for FBE in sidelink communications using shared spectrum). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to channel access techniques for FBE in sidelink communications using shared spectrum). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of channel access techniques for FBE in sidelink communications using shared spectrum as described herein. For example, the communications manager 720 may include an FFP configuration manager 725, an LBT manager 730, a sidelink communications manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first UE in accordance with examples as disclosed herein. The FFP configuration manager 725 may be configured as or otherwise support a means for transmitting, to at least a second UE, an indication of a FFP configuration for sidelink communications between at least the first UE and the second UE operating in a FBE mode, the FFP configuration including an idle period configuration that is coordinated across at least the first UE and the second UE for initiation of a channel access procedure. The LBT manager 730 may be configured as or otherwise support a means for monitoring, in accordance with the channel access procedure, a sidelink channel during a first idle period, the first idle period is identified based on the idle period configuration of the FFP configuration. The sidelink communications manager 735 may be configured as or otherwise support a means for transmitting a sidelink communication to at least the second UE based on the channel access procedure indicating that the sidelink channel is available for sidelink communications.

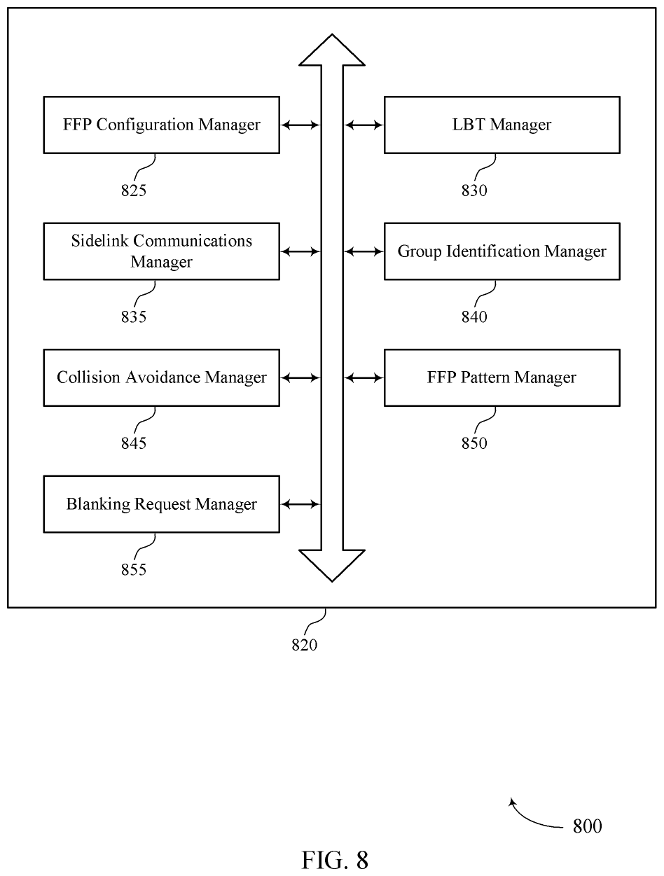

FIG. 8 shows a block diagram 800 of a communications manager 820 that supports channel access techniques for FBE in sidelink communications using shared spectrum in accordance with one or more aspects of the present disclosure. The communications manager 820 may be an example of aspects of a communications manager 620, a communications manager 720, or both, as described herein. The communications manager 820, or various components thereof, may be an example of means for performing various aspects of channel access techniques for FBE in sidelink communications using shared spectrum as described herein. For example, the communications manager 820 may include an FFP configuration manager 825, an LBT manager 830, a sidelink communications manager 835, a group identification manager 840, a collision avoidance manager 845, an FFP pattern manager 850, a blanking request manager 855, or any combination thereof. Each of these components may communicate, directly or indirectly, with one another (e.g., via one or more buses).

The communications manager 820 may support wireless communication at a first UE in accordance with examples as disclosed herein. The FFP configuration manager 825 may be configured as or otherwise support a means for transmitting, to at least a second UE, an indication of a FFP configuration for sidelink communications between at least the first UE and the second UE operating in a FBE mode, the FFP configuration including an idle period configuration that is coordinated across at least the first UE and the second UE for initiation of a channel access procedure. The LBT manager 830 may be configured as or otherwise support a means for monitoring, in accordance with the channel access procedure, a sidelink channel during a first idle period, the first idle period is identified based on the idle period configuration of the FFP configuration. The sidelink communications manager 835 may be configured as or otherwise support a means for transmitting a sidelink communication to at least the second UE based on the channel access procedure indicating that the sidelink channel is available for sidelink communications.

In some examples, the first UE and the second UE are in a first group of UEs, and where a same FFP configuration is used at each UE in the first group of UEs. In some examples, the group identification manager 840 may be configured as or otherwise support a means for receiving sidelink configuration information that indicates a zone identification for sidelink communications, where the first group of UEs each have a same zone identification. In some examples, the group identification manager 840 may be configured as or otherwise support a means for receiving sidelink configuration information that indicates a center node associated with the first group of UEs, and the first group of UEs includes UEs having a proximity to the center node that is less than a threshold value. In some examples, the center node is selected at a network entity or at one or more UEs of the first group of UEs.

In some examples, to support monitoring the sidelink channel, the collision avoidance manager 845 may be configured as or otherwise support a means for determining, based on a collision avoidance procedure, to contend for channel access during the first idle period, where the collision avoidance procedure is based on a random starting point for channel contention, a priority rule for channel contention, a reservation indication provided from the second UE, or any combinations thereof. In some examples, to support monitoring the sidelink channel, the collision avoidance manager 845 may be configured as or otherwise support a means for monitoring the sidelink channel during the first idle period is based on the collision avoidance procedure. In some examples, the collision avoidance procedure provides that higher priority traffic that is to be transmitted in the sidelink communication is mapped to an earlier starting time for initiating the channel access procedure. In some examples, the collision avoidance procedure prioritizes channel contention for UEs based on one or more of an amount of traffic to be transmitted in the sidelink communication, a priority of the traffic to be transmitted, a random selection based on an identification of the UE, a priority indication provided from a center node of a group of UEs that includes the first UE and the second UE, or any combinations thereof.

In some examples, the collision avoidance manager 845 may be configured as or otherwise support a means for receiving a FFP reservation indication from the second UE for a second idle period. In some examples, the collision avoidance manager 845 may be configured as or otherwise support a means for refraining from initiating the channel access procedure during the second idle period based on the FFP reservation indication. In some examples, the second UE has a different FFP configuration than the first UE, and a joint pattern is provided for performing the channel access procedure at each of the first UE and the second UE. In some examples, both the first UE and the second UE have a same zone identification for sidelink communications, and where each UE having the same zone identification follows an idle period associated with the FFP configuration of each UE having the same zone identification.

In some examples, the joint pattern provides that each UE having a first zone identification for sidelink communications and that shares a first FFP configuration follows an idle period associated with the first FFP configuration. In some examples, the joint pattern provides that the first UE blanks transmissions during a monitoring period of other UEs to which the first UE transmits sidelink communications. In some examples, the joint pattern further provides that each UE having the first zone identification blanks transmissions during the monitoring period of other UEs having the first zone identification and a different FFP configuration.

In some examples, the FFP configuration manager 825 may be configured as or otherwise support a means for receiving, via sidelink control information, an indication of the FFP configuration for at least the second UE. In some examples, the sidelink control information indicates one or more of a periodicity of the FFP, an offset associated with the FFP, a duration of an available channel occupancy time sharing during the FFP, or any combinations thereof. In some examples, the sidelink control information that provides the indication of the fixed frame configuration as part of an initial connection that initializes sidelink communications between the first UE and at least the second UE. In some examples, the sidelink control information is provided in an anchor UE groupcast transmission to a set of multiple UEs that each have a first zone identification for sidelink communications, or the sidelink control information is provided separately from each of the set of multiple UEs that each have the first zone identification.

In some examples, the blanking request manager 855 may be configured as or otherwise support a means for transmitting, prior to the monitoring the sidelink channel, a blanking request to at least the second UE that indicates the second UE is requested to refrain from transmitting during an LBT duration associated with the channel access procedure. In some examples, the blanking request is provided in a sidelink control information transmission from the first UE. In some examples, the blanking request is a one-shot blanking request for a single FFP, or a semi-static blanking request that applies to two or more FFPs. In some examples, the blanking request further indicates a priority associated with traffic to be transmitted from the first UE, and where the priority is used at least the second UE to determine whether to blank transmissions during the LBT duration. In some examples, the first UE provides an indication of whether the sidelink communication includes one or more symbols that have been blanked based on a received blanking request from a different UE.

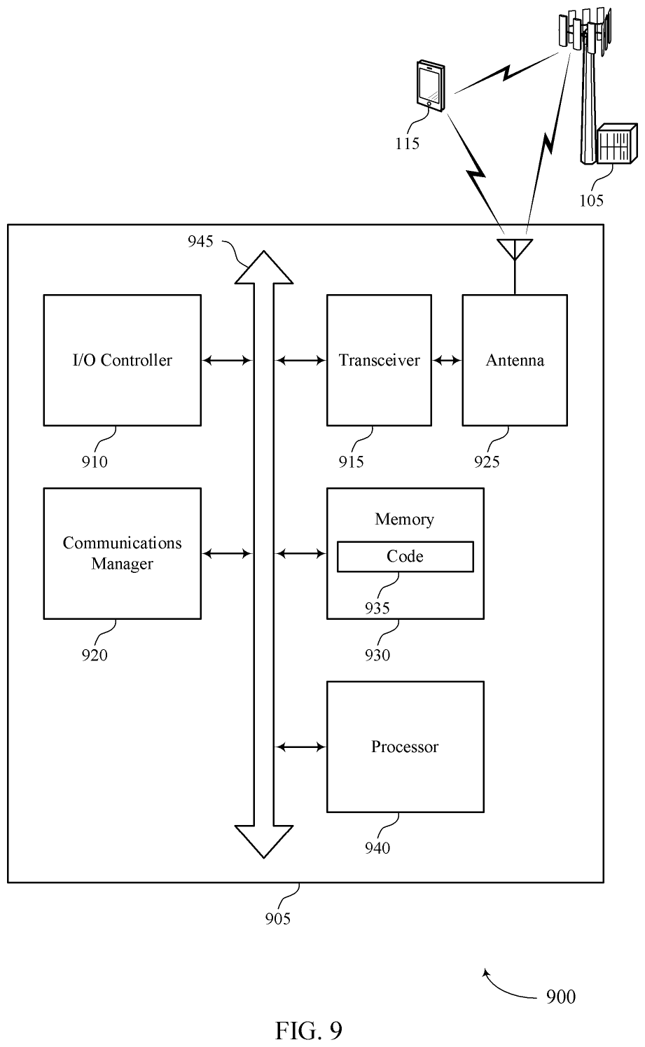

FIG. 9 shows a diagram of a system 900 including a device 905 that supports channel access techniques for FBE in sidelink communications using shared spectrum in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting channel access techniques for FBE in sidelink communications using shared spectrum). For example, the device 905 or a component of the device 905 may include a processor 940 and memory 930 coupled with or to the processor 940, the processor 940 and memory 930 configured to perform various functions described herein.

The communications manager 920 may support wireless communication at a first UE in accordance with examples as disclosed herein. For example, the communications manager 920 may be configured as or otherwise support a means for transmitting, to at least a second UE, an indication of a FFP configuration for sidelink communications between at least the first UE and the second UE operating in a FBE mode, the FFP configuration including an idle period configuration that is coordinated across at least the first UE and the second UE for initiation of a channel access procedure. The communications manager 920 may be configured as or otherwise support a means for monitoring, in accordance with the channel access procedure, a sidelink channel during a first idle period, the first idle period is identified based on the idle period configuration of the FFP configuration. The communications manager 920 may be configured as or otherwise support a means for transmitting a sidelink communication to at least the second UE based on the channel access procedure indicating that the sidelink channel is available for sidelink communications.

By including or configuring the communications manager 920 in accordance with examples as described herein, the device 905 may support techniques for reduced processing, reduced overhead, and reduced power consumption. In particular, because the device may provide COT sharing or may be configured with whether to initiate a channel access procedure or share a COT, the device may more efficiently contend for access to a shared channel and may avoid performing channel access procedures unnecessarily. As a result, less time and processing resources at the device may be used for channel access procedures, and the device may achieve the reduced processing, reduced overhead, reduced power consumption, or any combinations thereof.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of channel access techniques for FBE in sidelink communications using shared spectrum as described herein, or the processor 940 and the memory 930 may be otherwise configured to perform or support such operations.

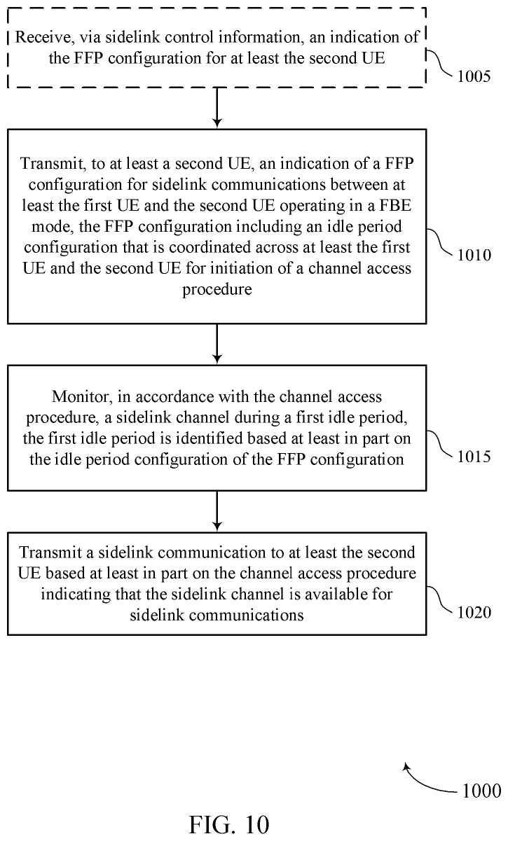

FIG. 10 shows a flowchart illustrating a method 1000 that supports channel access techniques for FBE in sidelink communications using shared spectrum in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

Optionally, at 1005, the method may include receiving, via sidelink control information, an indication of the FFP configuration for at least the second UE. The operations of 1005 may be performed in accordance with examples as disclosed herein. In some examples, aspects of the operations of 1005 may be performed by an FFP configuration manager 825 as described with reference to FIG. 8.

At 1010, the method may include transmitting, to at least a second UE, an indication of a FFP configuration for sidelink communications between at least the first UE and the second UE operating in a FBE mode, the FFP configuration including an idle period configuration that is coordinated across at least the first UE and the second UE for initiation of a channel access procedure. The operations of 1010 may be performed in accordance with examples as disclosed herein. In some examples, aspects of the operations of 1010 may be performed by an FFP configuration manager 825 as described with reference to FIG. 8.

At 1015, the method may include monitoring, in accordance with the channel access procedure, a sidelink channel during a first idle period, the first idle period is identified based on the idle period configuration of the FFP configuration. The operations of 1015 may be performed in accordance with examples as disclosed herein. In some examples, aspects of the operations of 1015 may be performed by an LBT manager 830 as described with reference to FIG. 8.

At 1020, the method may include transmitting a sidelink communication to at least the second UE based on the channel access procedure indicating that the sidelink channel is available for sidelink communications. The operations of 1020 may be performed in accordance with examples as disclosed herein. In some examples, aspects of the operations of 1020 may be performed by a sidelink communications manager 835 as described with reference to FIG. 8.

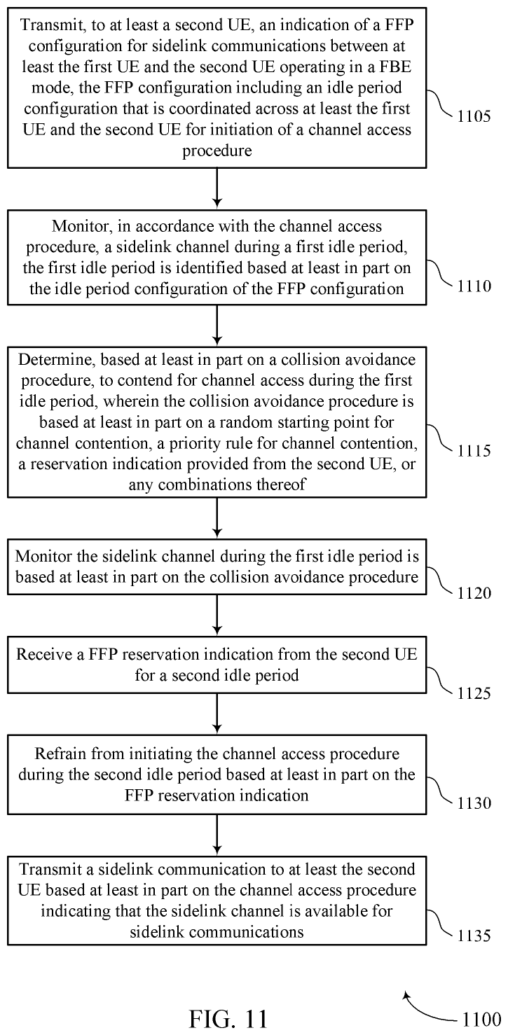

FIG. 11 shows a flowchart illustrating a method 1100 that supports channel access techniques for FBE in sidelink communications using shared spectrum in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include transmitting, to at least a second UE, an indication of a FFP configuration for sidelink communications between at least the first UE and the second UE operating in a FBE mode, the FFP configuration including an idle period configuration that is coordinated across at least the first UE and the second UE for initiation of a channel access procedure. The operations of 1105 may be performed in accordance with examples as disclosed herein. In some examples, aspects of the operations of 1105 may be performed by an FFP configuration manager 825 as described with reference to FIG. 8.

At 1110, the method may include monitoring, in accordance with the channel access procedure, a sidelink channel during a first idle period, the first idle period is identified based on the idle period configuration of the FFP configuration. The operations of 1110 may be performed in accordance with examples as disclosed herein. In some examples, aspects of the operations of 1110 may be performed by an LBT manager 830 as described with reference to FIG. 8.

At 1115, the method may include determining, based on a collision avoidance procedure, to contend for channel access during the first idle period, where the collision avoidance procedure is based on a random starting point for channel contention, a priority rule for channel contention, a reservation indication provided from the second UE, or any combinations thereof. The operations of 1115 may be performed in accordance with examples as disclosed herein. In some examples, aspects of the operations of 1115 may be performed by a collision avoidance manager 845 as described with reference to FIG. 8.

At 1120, the method may include monitoring the sidelink channel during the first idle period is based on the collision avoidance procedure. The operations of 1120 may be performed in accordance with examples as disclosed herein. In some examples, aspects of the operations of 1120 may be performed by a collision avoidance manager 845 as described with reference to FIG. 8.

At 1125, the method may include receiving a FFP reservation indication from the second UE for a second idle period. The operations of 1125 may be performed in accordance with examples as disclosed herein. In some examples, aspects of the operations of 1125 may be performed by a collision avoidance manager 845 as described with reference to FIG. 8.

At 1130, the method may include refraining from initiating the channel access procedure during the second idle period based on the FFP reservation indication. The operations of 1130 may be performed in accordance with examples as disclosed herein. In some examples, aspects of the operations of 1130 may be performed by a collision avoidance manager 845 as described with reference to FIG. 8.

At 1135, the method may include transmitting a sidelink communication to at least the second UE based on the channel access procedure indicating that the sidelink channel is available for sidelink communications. The operations of 1135 may be performed in accordance with examples as disclosed herein. In some examples, aspects of the operations of 1135 may be performed by a sidelink communications manager 835 as described with reference to FIG. 8.

The following provides an overview of aspects of the present disclosure:

Aspect 1: A method for wireless communication at a first UE, comprising: transmitting, to at least a second UE, an indication of a fixed frame period configuration for sidelink communications between at least the first UE and the second UE operating in a frame-based equipment mode, the fixed frame period configuration including an idle period configuration that is coordinated across at least the first UE and the second UE for initiation of a channel access procedure; monitoring, in accordance with the channel access procedure, a sidelink channel during a first idle period, the first idle period is identified based at least in part on the idle period configuration of the fixed frame period configuration; and transmitting a sidelink communication to at least the second UE based at least in part on the channel access procedure indicating that the sidelink channel is available for sidelink communications.

Aspect 2: The method of aspect 1, wherein the first UE and the second UE are in a first group of UEs, and wherein a same fixed frame period configuration is used at each UE in the first group of UEs.

Aspect 3: The method of aspect 2, further comprising: receiving sidelink configuration information that indicates a zone identification for sidelink communications, wherein the first group of UEs each have a same zone identification.

Aspect 4: The method of any of aspects 2 through 3, further comprising: receiving sidelink configuration information that indicates a center node associated with the first group of UEs, and the first group of UEs includes UEs having a proximity to the center node that is less than a threshold value.

Aspect 5: The method of aspect 4, wherein the center node is selected at a network entity or at one or more UEs of the first group of UEs.

Aspect 6: The method of any of aspects 1 through 5, wherein the monitoring the sidelink channel comprises: determining, based at least in part on a collision avoidance procedure, to contend for channel access during the first idle period, wherein the collision avoidance procedure is based at least in part on a random starting point for channel contention, a priority rule for channel contention, a reservation indication provided from the second UE, or any combinations thereof; and monitoring the sidelink channel during the first idle period is based at least in part on the collision avoidance procedure.

Aspect 7: The method of aspect 6, wherein the collision avoidance procedure provides that higher priority traffic that is to be transmitted in the sidelink communication is mapped to an earlier starting time for initiating the channel access procedure.

Aspect 8: The method of any of aspects 6 through 7, wherein the collision avoidance procedure prioritizes channel contention for UEs based at least in part on one or more of an amount of traffic to be transmitted in the sidelink communication, a priority of the traffic to be transmitted, a random selection based on an identification of the UE, a priority indication provided from a center node of a group of UEs that includes the first UE and the second UE, or any combinations thereof.

Aspect 9: The method of any of aspects 6 through 8, further comprising: receiving a fixed frame period reservation indication from the second UE for a second idle period; and refraining from initiating the channel access procedure during the second idle period based at least in part on the fixed frame period reservation indication.

Aspect 10: The method of any of aspects 1 through 9, wherein the second UE has a different fixed frame period configuration than the first UE, and a joint pattern is provided for performing the channel access procedure at each of the first UE and the second UE.

Aspect 11: The method of aspect 10, wherein both the first UE and the second UE have a same zone identification for sidelink communications, and where each UE having the same zone identification follows an idle period associated with the fixed frame period configuration of each UE having the same zone identification.

Aspect 12: The method of any of aspects 10 through 11, wherein the joint pattern provides that each UE having a first zone identification for sidelink communications and that shares a first fixed frame period configuration follows an idle period associated with the first fixed frame period configuration, and the joint pattern provides that the first UE blanks transmissions during a monitoring period of other UEs to which the first UE transmits sidelink communications.

Aspect 13: The method of aspect 12, wherein the joint pattern further provides that each UE having the first zone identification blanks transmissions during the monitoring period of other UEs having the first zone identification and a different fixed frame period configuration.

Aspect 14: The method of any of aspects 1 through 13, further comprising: receiving, via sidelink control information, an indication of the fixed frame period configuration for at least the second UE.

Aspect 15: The method of aspect 14, wherein the sidelink control information indicates one or more of a periodicity of the fixed frame period, an offset associated with the fixed frame period, a duration of an available channel occupancy time sharing during the fixed frame period, or any combinations thereof.

Aspect 16: The method of any of aspects 14 through 15, wherein the sidelink control information that provides the indication of the fixed frame configuration as part of an initial connection that initializes sidelink communications between the first UE and at least the second UE.

Aspect 17: The method of any of aspects 14 through 16, wherein the sidelink control information is provided in an anchor UE groupcast transmission to a plurality of UEs that each have a first zone identification for sidelink communications, or the sidelink control information is provided separately from each of the plurality of UEs that each have the first zone identification.

Aspect 18: The method of any of aspects 1 through 17, further comprising:

transmitting, prior to the monitoring the sidelink channel, a blanking request to at least the second UE that indicates the second UE is requested to refrain from transmitting during an LBT duration associated with the channel access procedure.

Aspect 19: The method of aspect 18, wherein the blanking request is provided in a sidelink control information transmission from the first UE.

Aspect 20: The method of any of aspects 18 through 19, wherein the blanking request is a one-shot blanking request for a single fixed frame period, or a semi-static blanking request that applies to two or more fixed frame periods.

Aspect 21: The method of any of aspects 18 through 20, wherein the blanking request further indicates a priority associated with traffic to be transmitted from the first UE, and wherein the priority is used at least at the second UE to determine whether to blank transmissions during the LBT duration.

Aspect 22: The method of any of aspects 18 through 21, wherein the first UE provides an indication of whether the sidelink communication includes one or more symbols that have been blanked based at least in part on a received blanking request from a different UE.

Aspect 23: An apparatus for wireless communication at a first UE, comprising a processor; memory coupled with the processor; and instructions stored in the memory and executable by the processor to cause the apparatus to perform a method of any of aspects 1 through 22.

Aspect 24: An apparatus for wireless communication at a first UE, comprising at least one means for performing a method of any of aspects 1 through 22.

Aspect 25: A non-transitory computer-readable medium storing code for wireless communication at a first UE, the code comprising instructions executable by a processor to perform a method of any of aspects 1 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first user equipment (UE), comprising:
transmitting, to at least a second UE, an indication of a fixed frame period configuration for sidelink communications between at least the first UE and the second UE operating in a frame-based equipment mode, the fixed frame period configuration including an idle period configuration that is coordinated across at least the first UE and the second UE for initiation of a channel access procedure;
monitoring, in accordance with the channel access procedure, a sidelink channel during a first idle period, the first idle period is identified based at least in part on the idle period configuration of the fixed frame period configuration; and
transmitting a sidelink communication to at least the second UE based at least in part on the channel access procedure indicating that the sidelink channel is available for sidelink communications.

2. The method of claim 1, wherein the first UE and the second UE are in a first group of UEs, and wherein a same fixed frame period configuration is used at each UE in the first group of UEs.

3. The method of claim 2, further comprising:
receiving sidelink configuration information that indicates a zone identification for sidelink communications, wherein the first group of UEs each have a same zone identification.

4. The method of claim 2, further comprising:
receiving sidelink configuration information that indicates a center node associated with the first group of UEs, and the first group of UEs includes UEs having a proximity to the center node that is less than a threshold value.

5. The method of claim 4, wherein the center node is selected at a network entity or at one or more UEs of the first group of UEs.

6. The method of claim 1, wherein the monitoring the sidelink channel comprises:
determining, based at least in part on a collision avoidance procedure, to contend for channel access during the first idle period, wherein the collision avoidance procedure is based at least in part on a random starting point for channel contention, a priority rule for channel contention, a reservation indication provided from the second UE, or any combinations thereof; and
monitoring the sidelink channel during the first idle period is based at least in part on the collision avoidance procedure.

7. The method of claim 6, wherein the collision avoidance procedure provides that higher priority traffic that is to be transmitted in the sidelink communication is mapped to an earlier starting time for initiating the channel access procedure.

8. The method of claim 6, wherein the collision avoidance procedure prioritizes channel contention for UEs based at least in part on one or more of an amount of traffic to be transmitted in the sidelink communication, a priority of the traffic to be transmitted, a random selection based on an identification of the UE, a priority indication provided from a center node of a group of UEs that includes the first UE and the second UE, or any combinations thereof.

9. The method of claim 6, further comprising:
receiving a fixed frame period reservation indication from the second UE for a second idle period; and
refraining from initiating the channel access procedure during the second idle period based at least in part on the fixed frame period reservation indication.

10. The method of claim 1, wherein the second UE has a different fixed frame period configuration than the first UE, and a joint pattern is provided for performing the channel access procedure at each of the first UE and the second UE.

11. The method of claim 10, wherein both the first UE and the second UE have a same zone identification for sidelink communications, and where each UE having the same zone identification follows an idle period associated with the fixed frame period configuration of each UE having the same zone identification.

12. The method of claim 10, wherein:
the joint pattern provides that each UE having a first zone identification for sidelink communications and that shares a first fixed frame period configuration follows an idle period associated with the first fixed frame period configuration, and
the joint pattern provides that the first UE blanks transmissions during a monitoring period of other UEs to which the first UE transmits sidelink communications.

13. The method of claim 12, wherein the joint pattern further provides that each UE having the first zone identification blanks transmissions during the monitoring period of other UEs having the first zone identification and a different fixed frame period configuration.

14. The method of claim 1, further comprising:
receiving, via sidelink control information, an indication of the fixed frame period configuration for at least the second UE.

15. The method of claim 14, wherein the sidelink control information indicates one or more of a periodicity of the fixed frame period, an offset associated with the fixed frame period, a duration of an available channel occupancy time sharing during the fixed frame period, or any combinations thereof.

16. The method of claim 14, wherein the sidelink control information that provides the indication of the fixed frame configuration as part of an initial connection that initializes sidelink communications between the first UE and at least the second UE.

17. The method of claim 14, wherein the sidelink control information is provided in an anchor UE groupcast transmission to a plurality of UEs that each have a first zone identification for sidelink communications, or the sidelink control information is provided separately from each of the plurality of UEs that each have the first zone identification.

18. The method of claim 1, further comprising:
transmitting, prior to the monitoring the sidelink channel, a blanking request to at least the second UE that indicates the second UE is requested to refrain from transmitting during a listen-before-talk (LBT) duration associated with the channel access procedure.

19. The method of claim 18, wherein the blanking request is provided in a sidelink control information transmission from the first UE.

20. The method of claim 18, wherein the blanking request is a one-shot blanking request for a single fixed frame period, or a semi-static blanking request that applies to two or more fixed frame periods.

21. The method of claim 18, wherein the blanking request further indicates a priority associated with traffic to be transmitted from the first UE, and wherein the priority is used at least the second UE to determine whether to blank transmissions during the LBT duration.

22. The method of claim 18, wherein the first UE provides an indication of whether the sidelink communication includes one or more symbols that have been blanked based at least in part on a received blanking request from a different UE.

23. An apparatus for wireless communication at a first user equipment (UE), comprising:
a processor;
memory coupled with the processor; and
instructions stored in the memory and executable by the processor to cause the apparatus to:
transmit, to at least a second UE, an indication of a fixed frame period configuration for sidelink communications between at least the first UE and the second UE operating in a frame-based equipment mode, the fixed frame period configuration including an idle period configuration that is coordinated across at least the first UE and the second UE for initiation of a channel access procedure;
monitor, in accordance with the channel access procedure, a sidelink channel during a first idle period, the first idle period is identified based at least in part on the idle period configuration of the fixed frame period configuration; and
transmit a sidelink communication to at least the second UE based at least in part on the channel access procedure indicating that the sidelink channel is available for sidelink communications.

24. The apparatus of claim 23, wherein the first UE and the second UE are in a first group of UEs, and wherein a same fixed frame period configuration is used at each UE in the first group of UEs.

25. The apparatus of claim 23, wherein the instructions to monitor the sidelink channel are executable by the processor to cause the apparatus to:
determine, based at least in part on a collision avoidance procedure, to contend for channel access during the first idle period, wherein the collision avoidance procedure is based at least in part on a random starting point for channel contention, a priority rule for channel contention, a reservation indication provided from the second UE, or any combinations thereof; and
monitor the sidelink channel during the first idle period is based at least in part on the collision avoidance procedure.

26. The apparatus of claim 23, wherein the second UE has a different fixed frame period configuration than the first UE, and a joint pattern is provided for performing the channel access procedure at each of the first UE and the second UE.

27. An apparatus for wireless communication at a first user equipment (UE), comprising:
means for transmitting, to at least a second UE, an indication of a fixed frame period configuration for sidelink communications between at least the first UE and the second UE operating in a frame-based equipment mode, the fixed frame period configuration including an idle period configuration that is coordinated across at least the first UE and the second UE for initiation of a channel access procedure;
means for monitoring, in accordance with the channel access procedure, a sidelink channel during a first idle period, the first idle period is identified based at least in part on the idle period configuration of the fixed frame period configuration; and
means for transmitting a sidelink communication to at least the second UE based at least in part on the channel access procedure indicating that the sidelink channel is available for sidelink communications.

28. The apparatus of claim 27, wherein the first UE and the second UE are in a first group of UEs, and wherein a same fixed frame period configuration is used at each UE in the first group of UEs.

29. A non-transitory computer-readable medium storing code for wireless communication at a first user equipment (UE), the code comprising instructions executable by a processor to:
transmit, to at least a second UE, an indication of a fixed frame period configuration for sidelink communications between at least the first UE and the second UE operating in a frame-based equipment mode, the fixed frame period configuration including an idle period configuration that is coordinated across at least the first UE and the second UE for initiation of a channel access procedure;
monitor, in accordance with the channel access procedure, a sidelink channel during a first idle period, the first idle period is identified based at least in part on the idle period configuration of the fixed frame period configuration; and
transmit a sidelink communication to at least the second UE based at least in part on the channel access procedure indicating that the sidelink channel is available for sidelink communications.

30. The non-transitory computer-readable medium of claim 29, wherein the first UE and the second UE are in a first group of UEs, and wherein a same fixed frame period configuration is used at each UE in the first group of UEs.
